(19) United States
(12) Patent Application Publication
(10) Pub. No.: US 2004/0131188 A1
(43) Pub. Date: Jul. 8, 2004

(54) Method of generating key data for successful communication during a network link

(75) Inventors: Chiao-Wei Wang, Ilan (TW); Hung-Ming Chen, Taipei (TW); Lu-Yun Tai, Taoyuan (TW); Chih-Chiang Hsieh, Miaoli (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/382,869

(22) Filed: Mar. 7, 2003

(30) Foreign Application Priority Data
Jan. 2, 2003 (TW) 92100060

(51) Int. Cl. H04L 9/00

(52) U.S. Cl. 380/270; 713/171

(57) ABSTRACT

A method of generating key data for successful communications during a network link, which is applied in two information devices with wireless fidelity (WiFi) wireless modules. The two information devices use identical non-private key data (SSID and WEP private key) to achieve an initial connection, and exchange their own unique network card ID numbers. The first information device and the second information device both generate new key data by utilizing the first unique ID number and the second unique ID number to ensure security of the network link.

### BACKGROUND OF THE INVENTION

1. Field of the Invention

The present invention relates to a method of generating key data for successful communication during a network link, which is applied in two information devices with wireless fidelity (WiFi) wireless modules.

2. Description of the Related Art

Currently, in a wireless networking environment, an information device with a wireless fidelity (WiFi) wireless module can perform a wireless network connection based on the setting of a basic mode or an Ad-hoc mode. The basic mode is a network mode for performing the wireless network connection via an access point, so the information device which selects the basic mode first needs to be connected to one access point, and will then be wirelessly connected to another information device to perform data communication and transmission. The Ad-hoc mode is a peer-to-peer direct data transmission mode between two related peers, without a wireless access point.

When two information devices want to perform network linking in the Ad-hoc mode, both information devices must have been set with an identical service set identifier (SSID) and a wired equivalent privacy (WEP) private key, so the two information devices are synchronously connected together. These two information devices then perform an automatic synchronous interchange according to a new SSID and a new WEP private key generated by the two information devices. Finally, the two information devices perform the network linking again with the new SSID and the new WEP private key. WEP is a security protocol for 802.11 wireless local networks. The operating principle of WEP is that both communicating ends have a set of encryption keys. When one end wants to send data, the data is encrypted by the set of encryption keys, and the receiving end uses the same set of encryption keys to decrypt and restore the encrypted data. Therefore, even if a hacker intercepts the encrypted data during transmission, the hacker will not be able to decrypt the encrypted data without the same set of encryption keys. The SSID is a parameter allowing an 802.11 wireless local network to have a special name, so that different wireless networks can exist in one region and also be used as a channel control mode.

However, in the prior method, in order to make two information devices successfully enter into a network connected status in the Ad-hoc mode, a user has to manually set up the information device. Therefore, before implementing a networked environment, the user is required to be familiar with the principle and setting method of the wireless network environment, which increases the difficulty of using a wireless network.

Therefore, it is desirable to provide an improved method of generating key data for successful communication during a network link to mitigate and/or obviate the aforementioned problems.

### SUMMARY OF THE INVENTION

A main objective of the present invention is to provide a method of generating key data for successful communication during a network link, which causes two information devices that want to perform an Ad-hoc connection to reset a new SSID and a new WEP private key together to connect automatically. Furthermore, after exchanging the new SSID and the new WEP private key, the connection will perform synchronous interchange according to the new SSID and the new WEP private key.

Another objective of the present invention is to provide a method of generating key data for successful communication during a network link, which causes two information devices to generate the key data automatically and to synchronously perform the network connection.

In order to achieve the above-mentioned objectives, the present invention provides a method of generating key data for successful communication during a network link between a first information device and a second information device, wherein the first information device and the second information device both have a network card, and each network card has its own unique ID number. The method includes: obtaining a first unique ID number of the first information device and a second unique ID number of the second information device; and generating key data by utilizing the first unique ID number and the second unique ID number.

The present invention further provides a preset process for a network link between a first information device and a second information device, wherein the first information device and the second information device both have a network card, and each network card has its own unique ID number. The process comprises: the first information device and the second information device communicating with each other with a pre-determined non-private key data; the first information device and the second information device both obtaining a first unique ID number of the first information device and a second unique ID number of the second information device; the first information device and the second information device both generating key data by utilizing the first unique ID number and the second unique ID number; and the first information device and the second information device using the key data so generated to start a network link.

The present invention further provides a preset process for a network link between a first information device and a second information device. The process comprises the first information device using a pre-determined non-private key data to communicate with the second information device; the first information obtaining a second unique ID number of the second information device from the second information device; the first information device generating key data by utilizing a first unique ID number of the first information device and the second unique ID number; and the first information device using the generated key data to start a network link.

Other objects, advantages, and novel features of the invention will become more apparent from the following detailed description when taken in conjunction with the accompanying drawings.

### BRIEF DESCRIPTION OF THE DRAWINGS

FIG. 1 illustrates an environment schematic drawing of the present invention.

FIG. 2 is a flowchart of an embodiment according to the present invention.

FIG. 3 is a flowchart of a first information device and a second information device both obtaining another network card ID according to the present invention.

### DETAILED DESCRIPTION OF THE PREFERRED EMBODIMENT

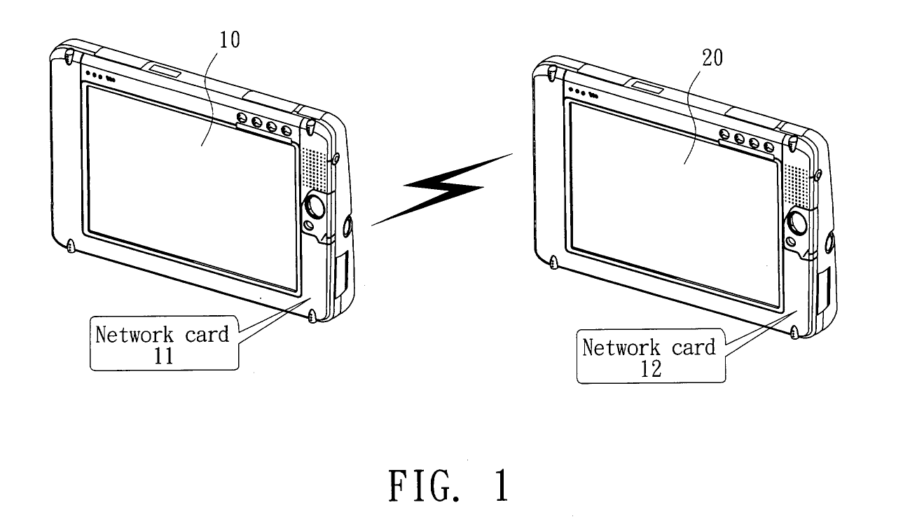

Please refer to FIG. 1. FIG. 1 illustrates an environment schematic drawing of the present invention. In a first embodiment of the present invention, a first information device 10 and a second information device 20 are both a WebPAD with a wireless fidelity (WiFi) wireless module and an Ad-hoc mode connection program. The first information device 10 and the second information device 20 can also be a tablet PC, a PDA, a pocket PC or other equivalent information device with a WiFi wireless module. The first information device 40 and the second information device 20 both have a network card 11,12. In this embodiment, the network card 11,12 is a WLAN card and has a unique MAC ID composed of a string with 12 digital characters. Furthermore, a Windows XP operation system (server host end) is installed in the first information device 10, and a Windows CE.NET operation system (client end) is installed in the second information device 20.

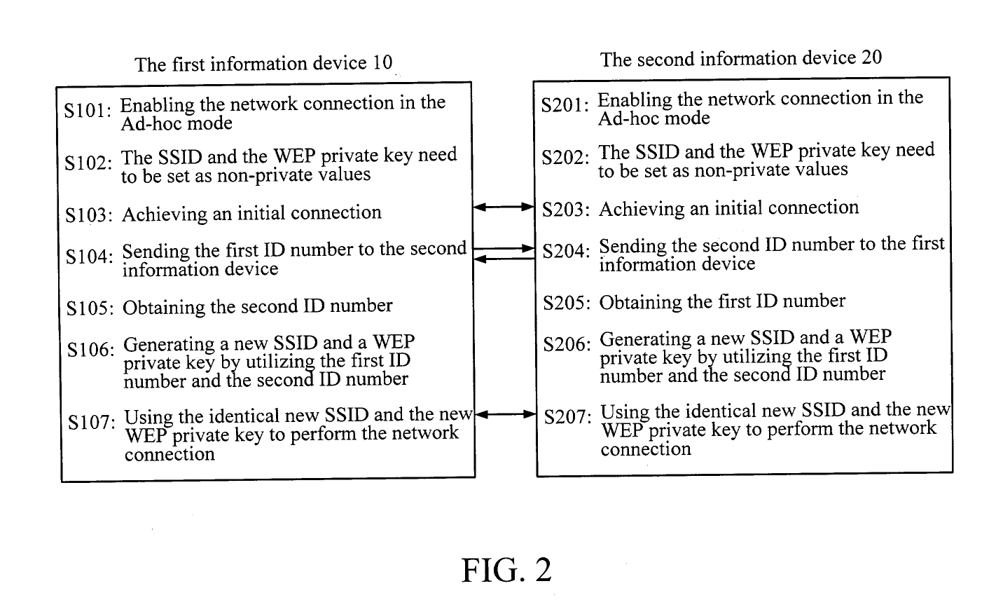

Please refer to FIG. 2. FIG. 2 is a flowchart of an embodiment according to the present invention. When the first information device 10 and the second information device 20 perform wireless connection in the Ad-hoc mode, the Ad-hoc mode connection programs in the first information device 10 and the second information device 20 will first be enabled synchronously (or non-synchronously) (step 101 and step 201). Since the information device 10 is the server host end and the second information device 20 is the client end, the Ad-hoc mode connection programs installed in them are different, but both are able to achieve a network connection in the Ad-hoc mode.

The most important condition for achieving the network connection in the Ad-hoc mode is the first information device 10 and the second information device 20 must have identical key data for successful communication, wherein the key data is composed of a service set identifier (SSID) and a wired equivalent privacy (WEP) private key. In order to make the first information device 10 and the second information device 20 achieve the network connection in the Ad-hoc mode, the SSID and the WEP private key need to be set with identical non-private values (step 102 and step 202). In this embodiment, the SSID is a string with 12 digital characters, and the WEP private key is a string with 26 digital characters. A default value for all characters of the SSID and the WEP private key is “1”, so the SSID is twelve “1”s and the WEP private key is twenty-six “1”s, these values are provided for an initial connection of the first information device 10 and the second information device 20 (step 103 and step 203). The default value can also be another setting as long as the information device 10 and the second information device 20 have the identical key data to perform the initial connection.

Next, the first information device 10 obtains a first network card ID number from the network card 11 and sends it to the second information device 20 (step 104), and the second information device 20 also obtains a second network card ID number from the network card 12 and sends it to the first information device 10 (step 204), so the first information device 10 and the second information device 20 both obtain another network card ID number from each other (step 105 and step 205).

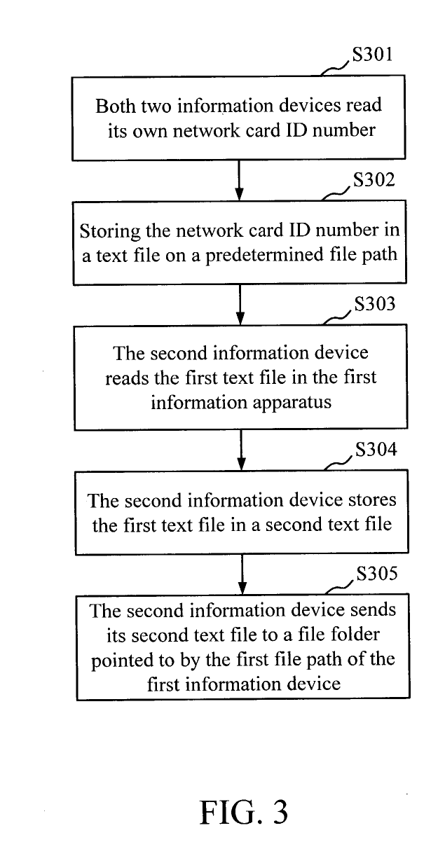

Please refer to FIG. 3. In this embodiment, FIG. 3 is a flowchart of the first information device 10 and the second information device 20 both obtaining another network card ID according to the present invention. First, the first information device 10 and the second information device 20 respectively read the network card ID number in the network card 11,12 (step 301), and store the network card ID number in a text file on a predetermined file path (step 302). Wherein, the first information device 10 stores the first network card ID number in a first text file on a first file path, and the second information device 20 stores the second network card ID number in a second text file on a second file path. The second information device 20 (as the client end) is connected to the first information device 10 (as the server host end), and the second information device 20 reads the first text file along the first file path in the first information device 10 (step 303) and copies the first text file back to the second information device 20 (step 304). Therefore, a file folder pointed to by the second file path of the second information device 20 stores both the first text file and the second text file. Next, the second information device 20 sends its second text file to a file folder pointed to by the first file path of the first information device 10 (step 305), so the file folder pointed to by the first file path of the first information device 10 stores both the first text file and the second text file.

Then, the first information device 10 and the second information device 20 generate a new SSID and a WEP private key by utilizing the first network card ID number and the second network card ID number to form new key data for successful communication (step 106 and step 206). Since the network card ID number is a string with 12 digital characters, the SSID is a string with 12 digital characters, and the WEP private key is a string with 26 digital characters, in this embodiment, the first network card ID number is set as the new SSID, and the second network card ID number is appended with fourteen “1”s to form the new WEP private key. For example, if the first network card ID number is “000012345678” and the second network card ID number is “000023456789”, the new SSID will be “000012345678 and the new WEP private key will be “00002345678911111111111111”.

Finally, the first information device 10 and the second information device 20 use the identical new SSID and the new WEP private key to perform the network connection in the Ad-hoc mode (step 107 and step 207) to ensure security of the network link.

In addition, in order to ensure security of the new SSID and the new WEP private key, after the first information device 10 and the second information device 20 generates the new SSID and the new WEP private key, first text file and the second text file will be deleted.

According to above-mentioned instruction, the method of the present invention causes two information devices that want to perform an Ad-hoc connection automatically generate new key data for successful communications, and also protects data to prevent the data from being intercepted.

The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

Although the present invention has been explained in relation to its preferred embodiment, it is to be understood that many other possible modifications and variations can be made without departing from the spirit and scope of the invention as hereinafter claimed.

What is claimed is:

1. A method of generating key data for successful communication during a network link between a first information device and a second information device, wherein the first information device and the second information device both have a network card, and each network card has its own unique ID number, the method comprising:
step A: obtaining a first unique ID number of the first information device and a second unique ID number of the second information device; and
step B: generating key data by utilizing the first unique ID number and the second unique ID number;
whereby the key data is unique to ensure network link security.

2. The method as claimed in claim 1, wherein the key data includes a setting ID and a private key.

3. The method as claimed in claim 2 is wherein the method is adapted for use in a wireless network connection.

4. The method as claimed in claim 3 wherein the method is adapted for use in a wireless network connection conforming to a wireless fidelity (WiFi) communications standard, wherein the setting ID is a service set identifier (SSID), and the private key is a wired equivalent privacy (WEP) private key.

5. A preset process for a network link between a first information device and a second information device, wherein the first information device and the second information device both have a network card, and each network card has its own unique ID number, the process comprising:
step A: the first information device and the second information device communicating with each other with a pre-determined non-private key data;
step B: the first information device and the second information device both obtaining a first unique ID number of the first information device and a second unique ID number of the second information device;
step C: the first information device and the second information device both generating key data by utilizing the first unique ID number and the second unique ID number; and
step D: the first information device and the second information device using the key data generated by step C to start a network link.

6. The process as claimed in claim 5, wherein the key data includes a setting ID and a private key.

7. The process as claimed in claim 6 wherein the process is adapted for use in a wireless network connection.

8. The process as claimed in claim 7 wherein the process is adapted for use in a wireless network connection conforming to a wireless fidelity (WiFi) communication standard, wherein the setting ID is a service set identifier (SSID), and the private key is a wired equivalent privacy (WEP) private key.

9. A preset process for a network link between a first information device and a second information device, wherein the first information device and the second information device both have a network card, and each network card has its own unique ID number, the process embedded in the first information device comprising:
step A: the first information device using a pre-determined non-private key data to communicate with the second information device;
step B: the first information obtaining a second unique ID number of the second information device from the second information device;
step C: the first information device generating key data by utilizing a first unique ID number of the first information device and the second unique ID number; and
step D: the first information device using the key data generated by step C to start a network link.

10. The process as claimed in claim 9, wherein the key data includes a setting ID and a private key.

11. The process as claimed in claim 10 wherein the process is adapted for use in a wireless network connection.

12. The process as claimed in claim 11 wherein the process is adapted for use in a wireless network connection conforming to a wireless fidelity (WiFi) communication standard, wherein the setting ID is a service set identifier (SSID), and the private key is a wired equivalent privacy (WEP) private key.
